(19) United States
(12) Patent Application Publication
(10) Pub. No.: US 2005/0014642 A1
(43) Pub. Date: Jan. 20, 2005

(54) Activated carbon and canister

(75) Inventors: Tokio Oi, Ogasa (JP); Hirokazu Aono, Ogasa (JP); Yuji Hayakawa, Obu (JP); Hideo Yamada, Obu (JP); Takashi Kato, Obu (JP)

Correspondence Address: STEVENS DAVIS MILLER & MOSHER, LLP, 1615 L STREET, NW, SUITE 850, WASHINGTON, DC, 20036, US

(73) Assignees: CATALER CORPORATION, Ogasa-gun (JP); AISAN KOGYO KABUSHIKI KAISHA, Obu-shi (JP)

(21) Appl. No.: 10/891,189

(22) Filed: Jul. 15, 2004

(30) Foreign Application Priority Data
Jul. 16, 2003 (JP) 2003-197701

(51) Int. Cl. C01B 31/08

(52) U.S. Cl. 502/416

(57) ABSTRACT

This invention provides activated carbon having excellent adsorption and desorption properties and a canister using such activated carbon. An organic substance is adsorbed on a base activated carbon having pores with a wide range of diameter to selectively occlude pores with small diameters. As the pores with small diameters are occluded, the activated carbon has excellent adsorption and desorption properties. A canister using this activated carbon has a decreased leakage of an adsorbate.

### FIELD OF THE INVENTION

The present invention relates to improvements on activated carbon and a canister.

### BACKGROUND OF THE INVENTION

Because of high volatility, a gasoline used as fuel for automobiles is vaporized in a fuel tank when a vehicle is running or is left parked under a blazing sun, and the produced gasoline vapor is released into an atmosphere. Gasoline vapor is also generated during refueling.

In order to prevent gasoline vapor from being released out of the vehicles, a canister is provided in each vehicle, and activated carbon is contained in the canister as an adsorbent to adsorb gasoline vapor. This adsorbent in the canister also serves for adsorbing gasoline vapor generated during refueling. The adsorbed gasoline vapor is desorbed (purged) from activated carbon in accordance with engine rotation, led into the engine via a suction pipe along with the air taken in from the outside, and burned there.

Generally, activated carbon is produced by first carbonizing a base material and then activating the carbonized material. Activated carbon has pores that function to adsorb gasoline vapor, and an activation is a process for developing the pores while controlling a pore diameter. Activated carbon used for the canisters has been required to have pores with a large opening diameter of from 20 to 50 Å for adsorbing and desorbing gasoline vapor. Such large-diameter pores are formed by conducting an activation by chemicals or a high-degree activation which is carried out under severer conditions than an ordinary activation procedure. (See, for instance, JP-A-2000-313611, JP-B-1-52324, and JP-A-63-30308).

High-degree activation or an activation by chemicals make it possible to produce activated carbon with large pore diameters, but on the other hand, it has the problem that the produced activated carbon is widened in the range of distribution of pore diameter. In other words, there still exist many pores with small opening diameters in such activated carbon.

### SUMMARY OF THE INVENTION

Even if gasoline vapor adsorbed on activated carbon in the canister is subjected to a desorption (purging) with an suction air, a part of the adsorbed gasoline vapor remains on activated carbon, and with a rise of temperature when a vehicle is left parked, a residual gasoline vapor is desorbed from activated carbon and released out of the vehicle. Especially in the case of the above-mentioned conventional activated carbon which has a wide range of distribution of pore diameter, the pores with small opening diameters have higher adsorptivity than the pores with large opening diameters, making it harder for the adsorbate to get desorbed (purged). Therefore, the adsorbate which remains desorbed (residue) in the pores with small opening diameters exists in large quantity, giving rise to the problem that it may cause a leakage of gasoline vapor on rise of ambient temperature to increase the amount of HC released (exhausted) into an atmosphere (bleed emissions) when the vehicle is left parked.

In view of the above, it is an object of the present invention to provide activated carbon for canisters which is capable of reducing the residual amount of gasoline vapor to minimize the leakage thereof.

Another object of the present invention is to provide a canister whereby it is possible to inhibit leakage (bleed emissions) of gasoline vapor into the atmosphere.

In order to accomplish the above objects, the first embodiment of the present invention provides activated carbon in which an organic compound is adsorbed on a base activated carbon having pores with a wide range of diameter to selectively occlude pores with small diameters.

The second embodiment of the present invention provides a pelletized coal-based activated carbon having a bulk density of 0.32 to 0.50 g/cm³, a butane activity of 10 to 17 g/100 ml, and a butane throughput capacity of 8 to 14 g/100 ml.

Butane activity may be expressed as an amount of saturation adsorption of butane, and butane throughput capacity is also called butane working capacity.

The third embodiment of the present invention provides activated carbon wherein the pellet size is 1.0 to 2.5 mm in diameter in the activated carbon of the second embodiment.

The fourth embodiment of the present invention provides a canister using activated carbon of the first, second or third embodiment as an adsorbent.

The fifth embodiment of the present invention provides a canister in which the activated carbon of the first, second or third embodiment is used at least at a part close to an atmosphere-opening port.

The sixth embodiment of the present invention provides a canister of the fifth embodiment having a multilayer structure.

### BRIEF DESCRIPTION OF THE DRAWINGS

FIG. 1 is a drawing showing results of determination of pore distribution of activated carbons for canister according to Example 1 of the present invention and Comparative Example 1.

FIG. 2 is a drawing showing results of determination of adsorbates adsorbed on the activated carbon for canister according to Example 1 of the present invention.

FIG. 3 is a drawing showing the relation between gasoline vapor adsorption and leakage in activated carbons for canister according to Example 1 of the present invention and Comparative Example 1.

FIG. 4 is a drawing showing the relation between gasoline vapor adsorption and leakage in the activated carbons for canister according to Example 2 of the present invention and Comparative Examples 2-5.

FIG. 5 is a drawing illustrating the relation between a residual amount of gasoline vapor in activated carbon and bleed emissions.

FIG. 6 is a drawing illustrating the relation between BWC and the residual amount of activated carbon.

FIG. 7 is a schematic longitudinal sectional view of Example 6 of the present invention.

FIG. 8 is a longitudinal sectional view of Example 6 of the present invention.

FIG. 9 is a schematic longitudinal sectional view of Example 9 of the present invention.

FIG. 10 is a schematic longitudinal sectional view of Example 10 of the present invention.

FIG. 11 is a schematic longitudinal sectional view of Example 11 of the present invention.

FIG. 12 is a bar graph showing comparisons of bleed emissions in the canisters of the present invention and a conventional canister.

FIG. 13 is a bar graph showing comparisons of adsorption in the canisters of the present invention and a conventional canister.

FIG. 14 is a bar graph showing-comparisons of a residual amount of activated carbons according to the present invention and a conventional product.

### DESCRIPTION OF REFERENCE NUMERALS

2, 3, 4: adsorbent layer
19, 19A: atmosphere-opening port
100: canister
101: trap canister

### DETAILED DESCRIPTION OF THE INVENTION

(First Embodiment)

Provided in the first embodiment of the present invention is activated carbon produced by adsorbing an organic compound on a base activated carbon having pores with a wide range of diameter to selectively occlude small pores. In the activated carbon of this embodiment, the pores with small diameters in a wide distribution of diameter are occluded by adsorbing an organic compound on the base activated carbon. Occlusion of the small pores conduces to narrowing of the range of distribution of pore diameter of the activated carbon. It also contributes to uniformalizing the adsorbing and desorbing performance of the respective pores. In this way, the adsorption and desorption properties of activated carbon can be stabilized.

Further, the occlusion of the pores with small opening diameters makes it less liable for the adsorbates to remain on activated carbon. That is, the occlusion of the pores with small opening diameters means that there no longer exist the pores with high adsorptivity (i.e. the adsorbates are hard to desorb) in the activated carbon.

As a consequence, when the activated carbon of the present invention is used as an adsorbent, it becomes possible to inhibit the occurrence of troubles due to the residues without affecting the normal adsorbing and desorbing activities of activated carbon.

In a production process of the activated carbon according to the present invention, the base activated carbon on which an organic compound is to be adsorbed has the pores with a wide range of distribution of diameter. That is, the base activated carbon used in the present invention has a plurality of pores differing in opening diameter. The expression “wide range of distribution of pores of the activated carbon on which an organic compound is adsorbed” signifies a situation where in use of the activated carbon as an adsorbent, the distribution of pores is wide enough to enable adsorption of different components.

The base activated carbon on which an organic compound is to be adsorbed in the present invention is not restricted in terms of quality; it is possible to use any type of activated carbon, including plant-based such as wood and coconut shell, mineral-based such as coal, and resin-based such as phenolic resins, as far as it has pores with a wide range of opening diameter. Also, the base activated carbon used in the present invention is not subject to any other specific restrictions. That is, it is possible to produce the activated carbon of the present invention by using an activated carbon obtained by carbonizing the base material and then subjecting it to an activation treatment such as a high-degree activation or an activation by chemicals.

In production of the activated carbon according to the present invention, an adsorption of an organic compound is preferably carried out under a heated condition as this makes it easier for the organic compound to enter the pores of activated carbon. When the temperature of the activated carbon is lowered at a state that the organic compound enters the pores, the pores with the smaller diameters than a prescribed value are occluded by the compound.

The heating temperature used for adsorbing an organic compound is not specified in the present invention. It is preferable to determine the heating temperature so that a desired distribution of pores for the activated carbon of the present invention may be obtained. Generally, a lowering of the heating temperature leads to narrowing of the distribution of pores of the produced activated carbon, minimizing the variation of the adsorbing and desorbing performance in each pore.

When an organic compound is adsorbed on the activated carbon in a sufficiently heated state, the organic compound is able to enter any of the pores in the activated carbon. The organic compound which has entered the pores with large diameters is not retained in the pores but takes its way out because of low adsorptivity of such large-diameter pores themselves (compared to the pores with smaller diameters). Since the organic compound is not adsorbed in the pores with large diameters, the large-diameter pores remain unoccluded even if the temperature lowers. It is notable that since the adsorbing performance of a porous body is dependent on also temperature, it is possible to select the diameters of the pores to be occluded by varying the heating temperature. That is, the distribution of pores of the produced activated carbon can be adjusted by controlling the heating temperature.

The activated carbon having an organic compound adsorbed thereon is preferably cooled in an inert gas atmosphere because, by so doing, the pores would not be occluded by anything other than the organic compound.

Adsorption of an organic compound is preferably performed with the organic compound being in a gaseous state. When the organic compound is in a gaseous state, its entrance into the pores of activated carbon is facilitated. That is, it becomes easier for the organic compound to get adsorbed in the pores. Also, with the organic compound being rendered into a gaseous state, it becomes possible for the organic compound to enter any of the pores of the activated carbon. It is desirable that the organic compound has a boiling point lower than the heating temperature. The organic compound used is preferably one which has a known boiling point.

The organic compound used in the present invention is preferably of the type which can be adsorbed on the pores with small opening diameters because a use of such type of organic compound makes it possible to produce activated carbon in which the pores with small diameters are occluded.

The activated carbon of the present invention is preferably one suited for use in a canister. The activated carbon of the present invention can be embodied as activated carbon in which the pores with small opening diameters are occluded by an organic compound. That is, the activated carbon of the present invention has a narrower distribution of pore diameter than an ordinary (conventional) activated carbon. Therefore, when the activated carbon of the present invention is used as an adsorbent for a canister, it is possible to prevent leakage of adsorbates.

In the activated carbon for canister, it is preferable to use naphthalene (C₁₀H₈, boiling point 218° C.) as the organic compound for occluding the pores, and the opening diameter of the pores (i.e. pore diameter) occluded by the organic compound is preferably less than 20 Å.

An example of the production process of the activated carbon for canister according to the present invention is shown below.

Firstly, a base activated carbon having pores with large opening diameters of from 20 to 50 Å and small opening diameters of less than 20 Å is produced by a conventional method. Naphthalene is adsorbed on the base activated carbon at a reaction temperature of 250° C. or above, and then allowed to cool in an inert gas atmosphere.

Activated carbon for canister can be produced by the foregoing procedure.

Naphthalene is used as the organic compound in the above-shown example of production process, but it is possible to use coal tar which is a naphthalene-containing organic compound. Even when coal tar is used, since the reaction temperature is set higher than the boiling point of naphthalene, after all of the components of coal tar have been adsorbed, components having a lower boiling point than naphthalene are volatilized with adjustment of the heating temperature, and a part of the pores are occluded by high-boiling components alone, because naphthalene is adsorbed on the base activated carbon. In this case, since the components with a lower boiling point than naphthalene may not be adsorbed on activated carbon by the effect of heating temperature, they may not give any influence to the ordinary adsorption of gasoline vapor.

The activated carbon of the present invention (first embodiment) is provided with excellent adsorption and desorption properties as an organic compound is adsorbed to occlude the pores with small opening diameters.

(Examples of First Embodiment)

The first embodiment of the present invention will be further illustrated by the following Examples 1 and 2.

In these examples, an activated carbon for canister was produced.

The base activated carbon used for providing the activated carbon for canister in these examples was prepared by pulverizing coal, molding the pulverized powder, carbonizing and then subjecting it to an activation by steam.

### EXAMPLE 1

Base activated carbon and coal tar (as the organic compound) were prepared at a volume ratio of 1:0.2 and mixed well. The mixture was supplied into an oven capable of airtight closure, then heated up to 450° C. in a nitrogen gas atmosphere over a period of one hour and maintained at this temperature for 30 minutes. Thereafter, nitrogen gas was introduced into the oven and the product in the oven was allowed to cool in this nitrogen gas atmosphere.

Activated carbon for canister of this example was produced by the above procedure.

### EXAMPLE 2

Base activated carbon was packed in a column, then heated up to 450° C. over a period of one hour while passing nitrogen gas through the column at a flow rate of 5 L/min, and retained at this temperature for 30 minutes. Thereby the residual substances such as atmospheric water adsorbed in the inside of the base activated carbon were removed.

Then, with the temperature in the column kept at 450° C. and with nitrogen gas passed through the column, a tar component gas (as organic compound) was introduced into the column. That is, a mixed gas comprising tar component gas and nitrogen gas was passed through the column. Supply of tar component gas was continued for one hour. This “tar component gas” is a gas containing, beside naphthalene, the substances with high boiling points (higher than coal tar of Example 1) such as anthracene. The concentration of the tar component gas in the mixed gas flowing into the column was 50%. The concentration of each gas was adjusted by its partial pressure.

After stopping supply of the tar component gas, the product was allowed to cool with nitrogen gas kept passed through the column.

In this way, activated carbon for canister of this example was produced.

### COMPARATIVE EXAMPLE 1

Comparative Example 1 is the base activated carbon described above.

### COMPARATIVE EXAMPLE 2

Comparative Example 2 is activated carbon for canister produced by the same procedure as in Example 1 except that the heating temperature was 150° C.

### COMPARATIVE EXAMPLE 3

Comparative Example 3 is activated carbon for canister produced by the same procedure as in Example 2 except that the heating temperature was 100° C.

### COMPARATIVE EXAMPLE 4

Base activated carbon was put into an acetone solution, and the solution was stirred well and then allowed to stand for one hour, whereby acetone was adsorbed on the base activated carbon. Then, the base activated carbon was taken out, supplied into a heating oven, thereby heated up to 200° C. under the atmospheric condition over a period of one hour, retained at this temperature for 30 minutes, and then allowed to cool under the atmospheric condition, thereby producing activated carbon for canister of this comparative example.

### COMPARATIVE EXAMPLE 5

Comparative Example 5 is activated carbon for canister produced by the same procedure as in Comparative Example 4 except that the heating temperature was 80° C.

(Evaluation)

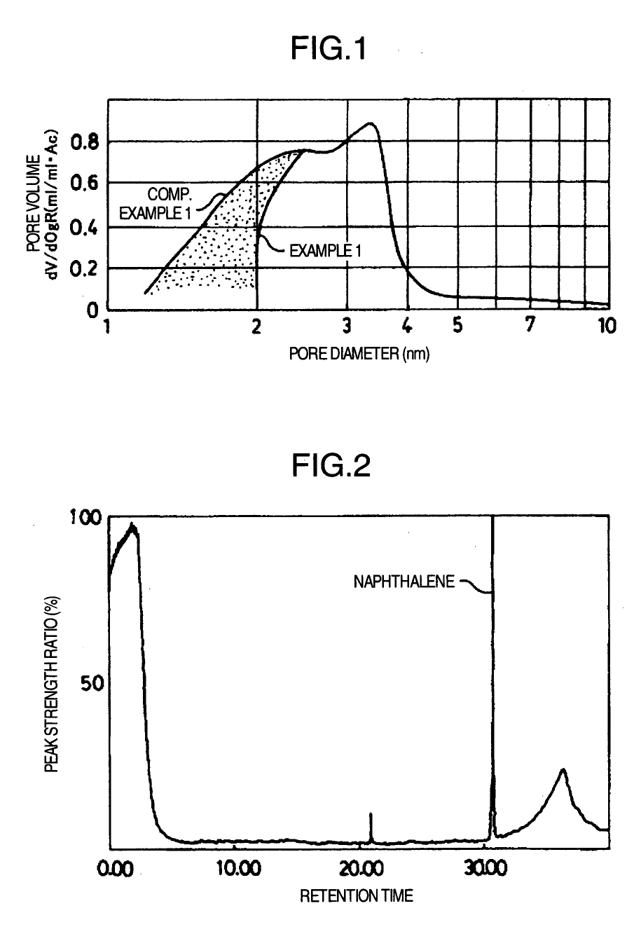

For the evaluation of the activated carbons for canister provided in the Examples of this invention and the Comparative Examples, first the distribution of pores of these activated carbons was determined. Results of determination of the pore distribution in the products of Example 1 and Comparative Example 1 are shown in FIG. 1.

Determination of the pore distribution was made according to N₂ adsorption method and benzene adsorption method.

It is seen from FIG. 1 that in the activated carbon for canister of Example 1, the diameters of most of the pores fall within the range of 20 to 50 Å (2 to 5 nm). In contrast, in the activated carbon for canister of Comparative Example 1, pore diameter distributes over a wider range, 10 to 50 Å (1 to 5 nm). It is also noted that the activated carbon for canister of Comparative Example 1 has pores with small diameters.

Here, the activated carbon for canister of Example 1 was heated to 250° C. and the analysis of the volatilized component was made. This volatilized component is a substance occluding the pores smaller than 20 Å (2 nm) of the activated carbon for canister of Example 1. It was confirmed that this component comprised naphthalene alone.

Identification of the organic compound was made by heating the activated carbon to 250° C. in an inert gas (nitrogen gas), separating the volatilized components by gas chromatography (GC-17A, Shimadzu Corp.) and conducting qualitative analysis of the separated components by mass spectrograph (SUN200, JEOL, Ltd.). Separation by gas chromatography was conducted by raising the temperature from −30° C. to 270° C. over a period of 40 minutes using a capillary column. Determination by mass spectrograph was made by setting the detector voltage at 330 V.

In the above-explained determination on the activated carbon for canister of Example 1, there was obtained only a peak at around 30.00 as shown in FIG. 2. This indicates that one kind of organic compound alone is adsorbed (occluding the small-diameter pores) on the activated carbon for canister of Example 1. This organic compound was identified as naphthalene by analysis.

The result of determination of pore distribution of the activated carbon for canister of Example 2 showed that the small-diameter pores are occluded as well as in Example 1.

In the determination of pore distribution of the activated carbons for canister of Comparative Examples 2 and 3, it was observed that the pores with larger diameters were occluded. This is due to the low reaction temperature in adsorbing coal tar (tar component gas).

The result of determination of pore distribution of the activated carbon for canister of Comparative Example 4 was substantially the same as that of Comparative Example 1. This result is due to the volatilization of acetone adsorbed in the pores by heating at 200° C.

The result of determination of pore distribution of the activated carbon for canister of Comparative Example 5 was substantially the same as in Comparative Example 4.

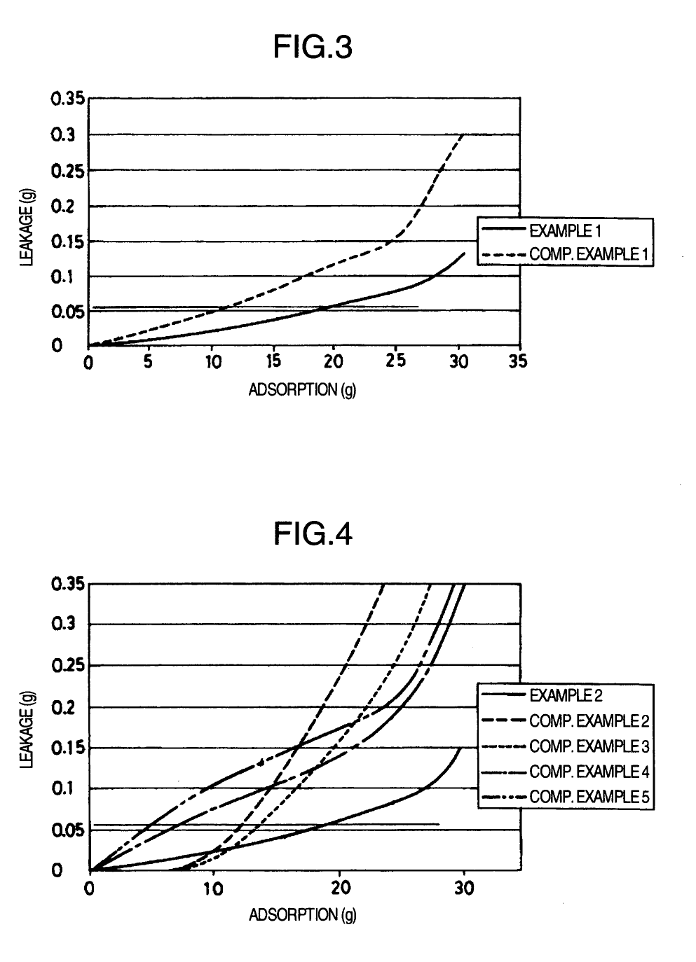

For the evaluation of the respective activated carbons for canister, a gasoline vapor adsorption and desorption test was conducted, and a subsequent leakage of gasoline vapor was measured. Results are shown in FIGS. 3 and 4.

In the test, adsorption and desorption of gasoline vapor were carried out with the ambient atmosphere maintained at 25° C. The activated carbon having gasoline vapor adsorbed thereon was left in the atmosphere for one hour, and then 50% butane gas (remainder: nitrogen gas) was adsorbed till 2 g break-through.

After one-hour standing, the adsorbate was desorbed at 300 BV and the activated carbon was left as it was overnight (for about 12 hours).

Then the temperature was raised from 20° C. to 35° C. over a period of 8 hours, and the leakage of the adsorbate from the activated carbon for canister was determined by electronic force balance.

It is seen from FIGS. 3 and 4 that the activated carbons for canister of Examples 1 and 2 are greatly lessened in leakage of gasoline vapor in comparison to the comparative examples. It will thus be understood that by adsorbing naphthalene having a boiling point of 218° C. on base activated carbon under a heated condition, there can be obtained activated carbon for canister restricted in leak of gasoline vapor.

(Second and Third Embodiments)

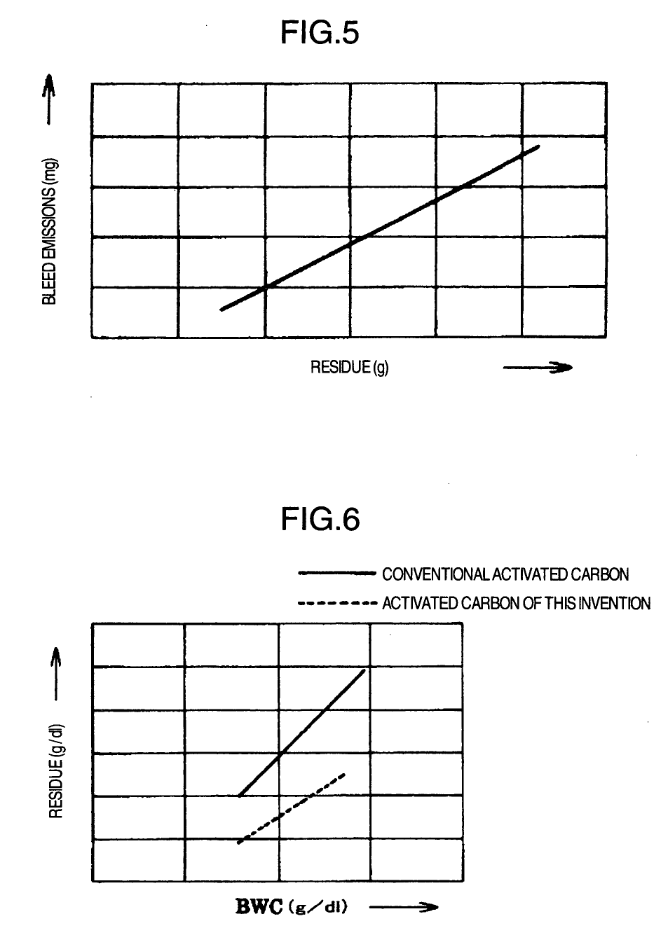

Bleed emissions of gasoline vapor from the canister is proportional to the residual amount of gasoline vapor in the canister. (See FIG. 5). Therefore, it is possible to lessen bleed emissions by reducing the residual amount of gasoline vapor. The bleed emissions of gasoline vapor and the residual amount of gasoline vapor were determined by electronic force balance.

Butane working capacity (BWC) is expressed by the mean value of the stabilized amounts of adsorption and desorption in a test where butane gas is adsorbed on the activated carbon in the canister under the specified conditions and then purged (desorbed) under the specified conditions, and this adsorption and desorption are repeated a predetermined number of times. (The amounts of the adsorption and desorption were determined by electronic force balance.) Residual amount signifies the weight of butane gas accumulated in the adsorbent (activated carbon) in the canister after the above test. BWC is in a linear relation with the residual amount as shown in FIG. 6. With the activated carbons according to the first, second and third embodiments of the present invention, it is possible to reduce the residual amount as compared with the conventional activated carbon when BWC performance is the same, as noted from a graphic comparison in FIG. 6. Thus, the residual amount is further lessened in comparison with the conventional activated carbon when BWC performance is low.

(Examples of Second and Third Embodiments)

Coal-based starting material was prepared as pellets having a size of 1.0 to 2.5 mm in diameter, and this material was activated by properly selecting the activation conditions (temperature and time) to produce the base activated carbon having a bulk density of 0.32 to 0.50 g/cm³, a butane activity (saturated butane adsorption) of 10 to 17 g/100 ml, and BWC of 8 to 14 g/100 ml. The “saturated butane adsorption” is expressed by an amount of 100% butane which an activated carbon can adsorb in a designated vessel under constant temperature conditions, provided that the adsorbed amount is determined by a weight change. The “Butane working capacity (BWC)” is expressed by a weight change range of a butane gas which an activated carbon can repeatedly adsorb and desorb in a designated vessel under constant temperature conditions, provided that the adsorption and desorption are conducted under designated conditions.

Then this base activated carbon was treated with an organic compound, for example, coal tar (tar coating) as in Example 1 to occlude the pores smaller than a certain size in opening diameter. In this way, the activated carbons of the second and third embodiments of the present invention were completed. The procedure of Example 2 described above may be used for the pore occlusion treatment.

It is to be noted that when bulk density is decreased, the temperature of activated carbon in the adsorption and desorption reaction of gasoline vapor tends to rise up, making leakage of gasoline vapor more likely to occur, resulting in a deteriorated working performance of the activated carbon. Therefore, bulk density is preferably set at 0.32 g/cm³ or above. The upper limit of bulk density may be 0.50 g/cm³ or less in view of qualitative restrictions.

### EXAMPLE 3

A coal-based starting material prepared as pellets having a size of 1.0 to 2.5 mm in diameter was activated to produce the base activated carbon having a butane activity of 14 to 17 g/100 ml, BWC of 12 to 14 g/100 ml and a bulk density of 0.35 g/cm³, and this base activated carbon was tar-coated as in the preceding example to occlude the pores with the opening diameters smaller than a certain size. The thus obtained activated carbon showed the residual amount was 2.3 g/100 ml. Also, this activated carbon showed a butane activity of 15.3 g/100 ml and BWC of 13.0 g/100 ml.

### EXAMPLE 4

A coal-based starting material prepared as pellets having a size of 1.0 to 2.5 mm in diameter was activated to produce the base activated carbon having a butane activity of 12 to 13 g/100 ml, BWC of 10 to 11 g/100 ml and a bulk density of 0.40 g/cm³, and this base activated carbon was tar-coated as in the preceding examples to occlude the pores with the opening diameters smaller than a certain size. The thus obtained activated carbon showed the following test results: residual amount, 1.6 g/100 ml; butane activity, 12.0 g/100 ml; BWC, 10.4 g/100 ml.

### EXAMPLE 5

A coal-based starting material prepared as pellets with a size of 1.0 to 2.5 mm in diameter was activated to produce the base activated carbon having a butane activity of 10 to 11 g/100 ml, BWC of 8 to 9 g/100 ml and a bulk density of 0.45 g/cm³, and this base activated carbon was tar coated as in the preceding examples to occlude the pores smaller than a certain size in opening diameter. The thus obtained activated carbon showed the following rest results: residual amount, 1.3 g/100 ml; butane activity, 10.1 g/100 ml; BWC, 8.8 g/100 ml.

(Comparison Between Embodiments of Examples 3, 4 and 5 and Two Types of Conventional Activated Carbon)

A comparison between the embodiments of Examples 3, 4 and 5 and the conventional activated carbons (1) and (2) is shown in Table 1 below.

TABLE 1

ASTM

| | | Residual | Butane | Bulk |
|---|---|---|---|---|
| | BWC | amount | activity | density |
| | (g/100 ml) | (g/100 ml) | (g/100 ml) | (g/cm³) |
| Example 3 | 13.0 | 2.3 | 15.3 | 0.35 |
| Example 4 | 10.4 | 1.6 | 12.0 | 0.40 |
| Example 5 | 8.8 | 1.3 | 10.1 | 0.45 |
| Conventional | 14.5 | 3.2 | 17.7 | 0.28 |
| activated | | | | |
| carbon (1) | | | | |
| Conventional | 11.2 | 2.0 | 13.2 | 0.35 |
| activated | | | | |
| carbon (2) | | | | |

The results of measurement of pore volumes in the embodiments of Examples 3-5 and the conventional activated carbons (1) and (2) are shown in Table 2 for reference. Unit of the figures showing the pore volumes in Table 2 is ml/mlAC.

TABLE 2

| | Pore diameter | | |
|---|---|---|---|
| | (opening diameter) nm | | |
| | less than 2 | 2 to 50 | over 50 |
| Example 3 | 0.138 | 0.217 | 0.005 |
| Example 4 | 0.109 | 0.179 | 0.003 |
| Example 5 | 0.102 | 0.177 | 0.003 |
| Conventional | 0.181 | 0.250 | 0.009 |
| activated | | | |
| carbon (1) | | | |
| Conventional | 0.128 | 0.220 | 0.007 |
| activated | | | |
| carbon (2) | | | |

Percentage of each division of opening diameter in the distribution of pores in the embodiments of Examples 3-5 and the conventional activated carbons (1) and (2) is shown in Table 3 for reference. The percentage given in Table 3 was calculated based on the pore volumes shown in Table 2.

TABLE 3

| | Pore diameter | | |
|---|---|---|---|
| | (opening diameter) nm | | |
| | less than 2 | 2 to 50 | over 50 |
| Example 3 | 38.333 | 60.278 | 1.389 |
| Example 4 | 37.457 | 61.512 | 1.031 |
| Example 5 | 36.170 | 62.766 | 1.064 |
| Conventional | 41.136 | 56.818 | 2.045 |
| activated | | | |
| carbon (1) | | | |
| Conventional | 36.056 | 61.972 | 1.972 |
| activated | | | |
| carbon (2) | | | |

(Fourth to Sixth Embodiments)

In the activated carbons available with the prior art, because of a high residue of gasoline vapor, the amount of gasoline vapor released into the atmosphere (bleed emissions) is large when the vehicle is left parked.

The fourth, fifth and sixth embodiments of the present invention can realize a canister which is capable of suppressing to the minimum the diffusive tendency in the adsorbent layer of the canister and positively adsorbing the influent vaporized fuel to inhibit its release into the atmosphere, by using the above-described activated carbon of the first, second or third embodiment that can reduce the residual amount of gasoline vapor. The activated carbon of the present invention is preferably used at least at a part of the canister located close to an atmosphere port. Application to a canister of a multi-layer structure is advantageous as more effective use of performance of the activated carbon of this invention is possible.

Next, the modes of practice of the above embodiments of the present invention are explained with reference to some examples.

### EXAMPLE 6

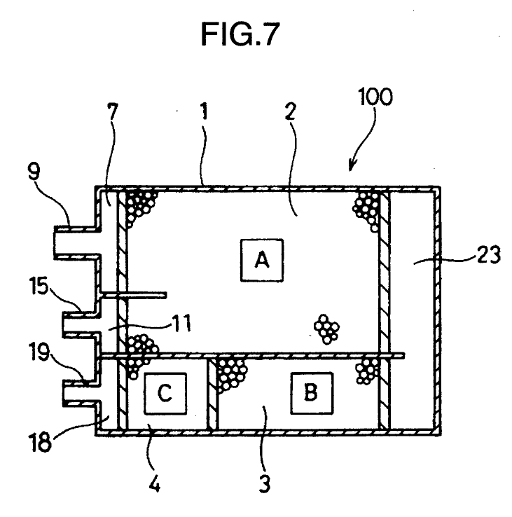

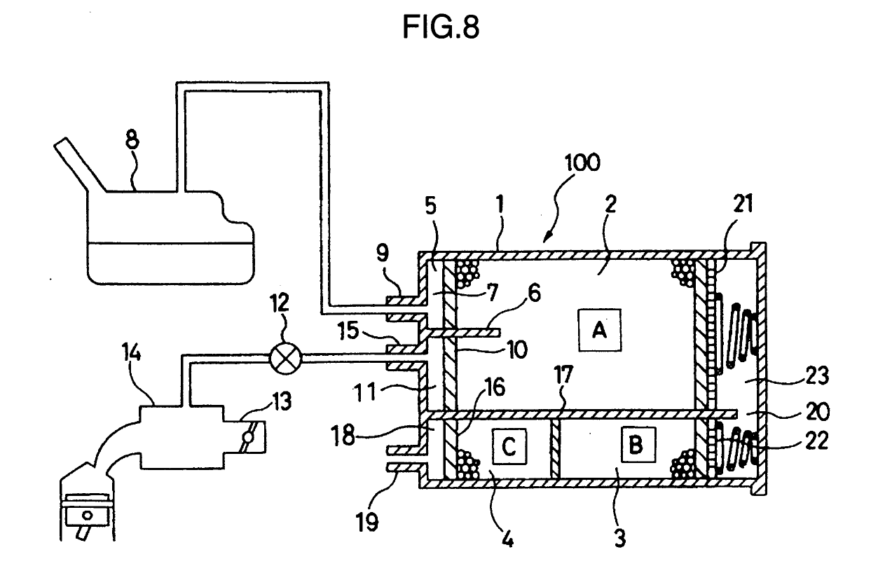

Referring to the accompanying drawings, FIG. 7 is a schematic longitudinal sectional view of the canister of Example 6, and FIG. 8 is a longitudinal sectional view of a principal part of the canister mounted on an automobile. In the embodiment shown in FIGS. 7 and 8, case 1 of canister 100 is of a three-layer structure consisting of A layer 2, B layer 3 and C layer 4, and tank port 9 communicated to the top of fuel tank 8 opens into first space 7 defined by case 1, filter 5 and partition plate 6. Opening into second space 11 defined by case 1, filter 10 and partition plate 6 is purge port 15 connected to surge tank 14 via flow control valve 12 and suction pipe 13. Port 19 which communicates with the atmosphere opens into third space 18 defined by case 1, filter 16 and partition wall 17. Connecting passage 20 is provided at the end of partition wall 17 (at the right end in the drawing), and fourth space 23 is formed by case 1 and plates 21, 22. The adsorbent layers (A layer 2, B layer 3 and C layer 4) are arranged in series relative to the flow of vaporized fuel with the interposition of fourth space 23.

The first adsorbent layer (A layer 2) and the second adsorbent layer (B layer 3) are loaded with activated carbon of Example 3, and the third adsorbent layer (C layer 4) is loaded with activated carbon of Example 4. By using activated carbon of Example 3 in A and B layers, it is possible to reduce the residue in these layers in comparison with the conventional products. Also, since the amount of gasoline vapor diffused is proportional to the residual amount, the amount of the residual composition diffused from A and B layers to C layer is lessened. The residual amount of activated carbon of Example 4 in C layer is less than the residual amount of activated carbon of Example 3 loaded in A and B layers as shown in Table 1. Increase of the residual amount due to diffusion is also lessened as compared with the conventional products. Thus, a reduction of bleed emissions (amount of gasoline vapor released into the atmosphere) is realized.

In Example 6, as described above, bleed emissions was reduced while keeping the gasoline vapor adsorption at the same level as the conventional products. By using activated carbon of Example 3 in A and B layers to secure high adsorption of gasoline vapor, and by using activated carbon of Example 4 in C layer 4, it is possible to reduce bleed emissions.

### EXAMPLE 7

The canister structure in Example 7 is the same as shown in FIGS. 7 and 8, but the combination of activated carbons loaded in the first, second and third adsorbent layers, or A, B and C layers 2, 3 and 4, is different from Example 6.

In Example 7, A layer 2 in FIGS. 7 and 8 is loaded with activated carbon of Example 3 while B layer 3 and C layer 4 are loaded with activated carbon of Example 4.

When activated carbon of Example 3 is used in A layer, the residue in A layer can be reduced as compared with the conventional products, resulting in a reduced amount of diffusion of the residual composition from A layer to B layer. Also, the residues in B layer 3 and C layer 4 become less than when using activated carbon of Example 3, so that the amount of diffusion of the residual composition from B layer 3 to C layer 4 is further lessened than in Example 6. Thus, bleed emissions can be lessened more than possible in Example 6.

In Example 7, although gasoline vapor adsorption is slightly lower than in Example 6, bleed emissions can be reduced more than effectible in Example 6. This was made possible by using activated carbon of Example 3 in A layer 3 to provide a desired degree of gasoline vapor adsorption and by using activated carbon of Example 4 in B layer 3 and C layer 4.

Thus, it is possible to lessen bleed emissions with a medium degree of gasoline vapor adsorption.

### EXAMPLE 8

The general layout of the canister of this example is identical with FIGS. 7 and 8, but bleed emissions can be reduced by using activated carbon of Example 4 in A layer 2, B layer 3 and C layer 4. Although gasoline vapor adsorption is lower than in Example 7, bleed emissions can be reduced further than achievable in Example 7.

In Example 8, as activated carbon of Example 4 is used for A layer 2, the residue can be reduced more than in Example 7 as seen from Table 1, allowing a corresponding decrease in diffusion from A layer 2 to B layer 3. Also, the residual amount in B layer 3 is reduced more than in Example 7 as so is diffusion of the residues from B layer 3 to C layer 4. Thus, since the residual amount in C layer 4 is reduced more than observed in Example 7, bleed emissions can be lessened by a greater degree than in Example 7.

### EXAMPLE 9

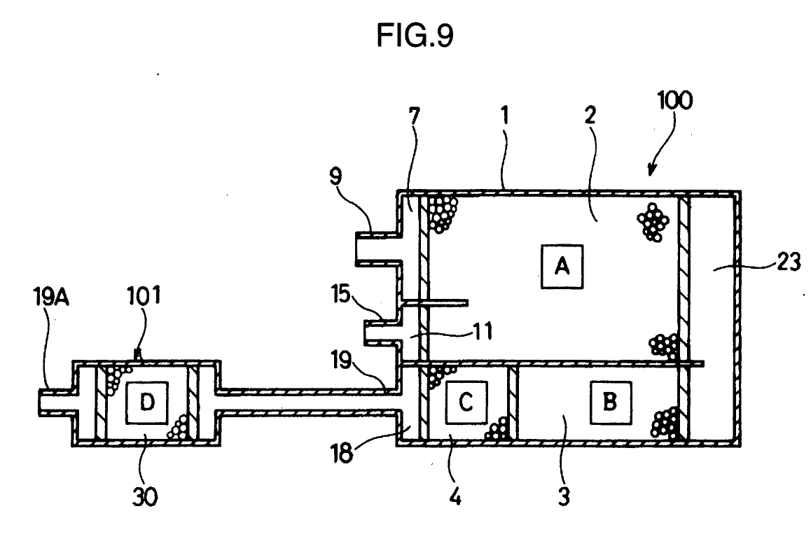

In this example, as shown in FIG. 9, a trap canister 101 having D layer 30 is connected to port 19 of a three-layer structure canister 100. At the left end (in the drawing) of trap canister 101 is provided port 19A which opens to the atmosphere.

In Example 9, activated carbon of Example 3 is loaded in A layer 2 and B layer 3, activated carbon of Example 4 in C layer 4 and activated carbon of Example 5 in D layer 30 of trap canister 101.

Use of activated carbon of Example 5 for D layer 30 of trap canister 101 realizes a remarkable reduction of residue (see Table 1). Canister 100 is the same as that of Example 6 and capable of reducing bleed emissions as compared with the conventional products. Therefore, bleed emissions from canister 100 is slight. It needs to adsorb a slight amount of gasoline vapor in trap canister 101, but by using activated carbon of Example 5 in D layer 30, it is possible to adsorb a slight amount of gasoline vapor and to reduce bleed emissions to almost zero.

Thus, in Example 9, bleed emissions can be lessened more than possible with Example 8, and consequently a high rate of adsorption of gasoline vapor and a great reduction of bleed emissions can be realized. That is, this example has the effect of reducing bleed emissions below the level of Example 8 with the same rate of adsorption of gasoline vapor as the conventional products.

### EXAMPLE 10

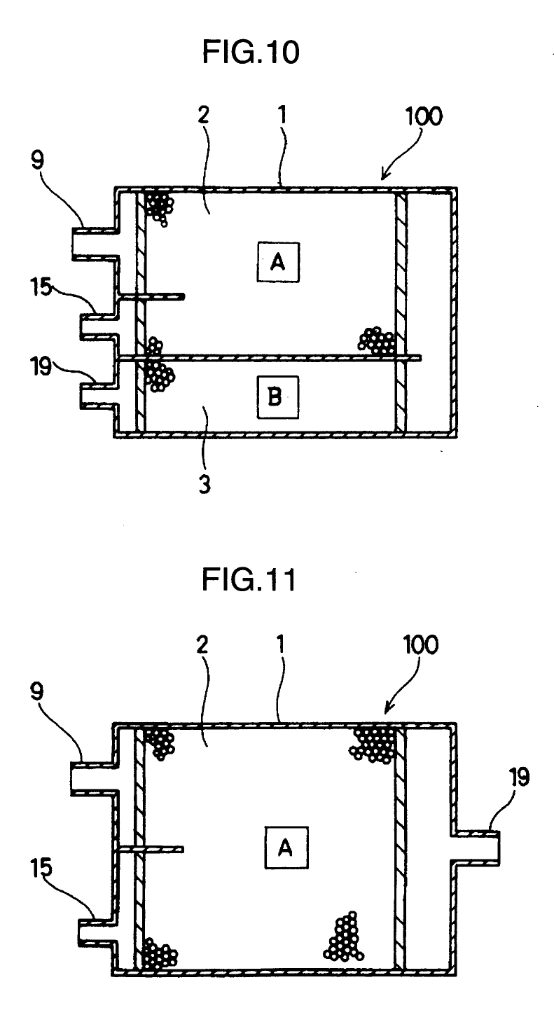

As shown in FIG. 10, canister 100 is of a two-layer structure consisting of A layer 2 and B layer 3, and activated carbon of this invention, for example, activated carbon of Example 3, 4 or 5 is loaded in B layer 3 at least at its portion located close to atmosphere-opening port 19.

The canister structure can be simplified by altering the three-layer structure of FIGS. 7 and 8 to the two-layer structure, if the bleed emissions rate can be left at the same level as in the prior art.

### EXAMPLE 11

Example 11 shown in FIG. 11 is of a single-layer structure (having A layer 2 alone). Its structure is further simplified than Example 10, and it is possible to minimize bleed emissions by using any one of the activated carbons according to the present invention.

(Description of the Effect of Examples)

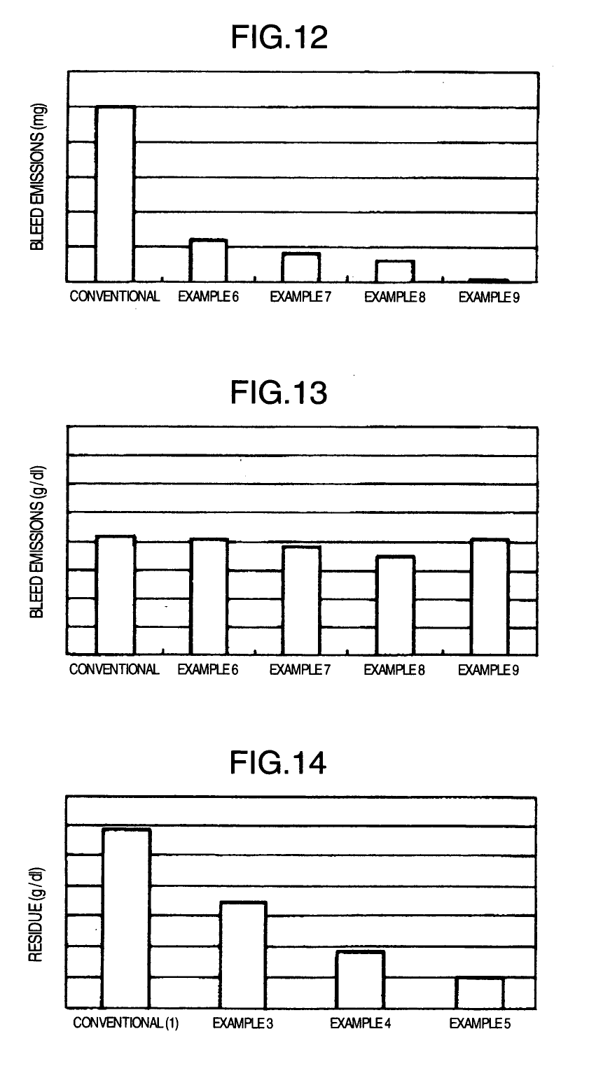

A comparison of bleed emissions in the canisters according to Examples 6, 7, 8 and 9 of the present invention and a conventional canister is shown in FIG. 12, from which the effect of the examples of the present invention is obvious.

A similar comparison of adsorption is shown in FIG. 13. No much difference is seen between the canisters of Examples 6-9 and the conventional one.

The amount of residue after determination of BWC with the activated carbons of the present invention being used for the canisters is shown in FIG. 14. This effect is also apparent from Table 1 shown before.

Effects of the Invention

The activated carbons according to the present invention, particularly the first embodiment of the present invention is capable of reducing the residual amount of gasoline vapor and thereby lessening the leakage thereof, so that it is suited for use as activated carbon for canisters.

The activated carbons of the second and third embodiments of the present invention are also capable of reducing the residual amount of gasoline vapor to lessen its leakage and so-called bleed emissions.

Further, with the fourth, fifth and sixth embodiments, it is possible to increase adsorption of gasoline vapor and to suppress the amount of gasoline vapor released into the atmosphere when the vehicle is left parked. The amount of gasoline vapor released can be further reduced by employing a multilayer structure for the canisters. If bleed emissions is allowed to remain at the same level as conventional, the canister structure can be simplified. For instance, three-layer structure may be altered to two-layer structure, or two-layer structure to single-layer structure with no compromise in working efficiency.

1. Activated carbon in which an organic compound is adsorbed on a base activated carbon having pores with a wide range of diameter to selectively occlude pores with small diameters.

2. Activated carbon comprising pelletized coal-based activated carbon having a bulk density of 0.32 to 0.50 g/cm³, a butane activity of 10 to 17 g/100 ml, and a butane working capacity of 8 to 14 g/100 ml.

3. Activated carbon according to claim 2, wherein the size of the pellets is 1.0 to 2.5 mm in diameter.

4. A canister in which the activated carbon according to claim 1, 2 or 3 is used as an adsorbent.

5. A canister in which the activated carbon according to claim 1, 2 or 3 is used at least at a part close to an atmosphere-opening port.

6. A canister according to claim 5 having a multilayer structure.
